(19) United States
(12) Patent Application Publication
(10) Pub. No.: US 2011/0144952 A1
(43) Pub. Date: Jun. 16, 2011

(54) MEASUREMENT APPARATUS AND METHOD FOR RAPID VERIFICATION OF CRITICAL RADIOLOGICAL LEVELS IN MEDICAL DIAGNOSTIC, TREATMENT AND NONINVASIVE SCREENING EQUIPMENT

(76) Inventors: NASIR J. ZAIDI, Valencia, CA (US); Kenneth A. Miller, Simi Valley, CA (US)

(21) Appl. No.: 12/965,627

(22) Filed: Dec. 10, 2010

Related U.S. Application Data
(60) Provisional application No. 61/283,956, filed on Dec. 10, 2009.

(51) Int. Cl. G06F 15/00

(52) U.S. Cl. 702/189

(57) ABSTRACT

A portable measurement apparatus and method for independent in situ analysis of emitted radiation, the patient or subject's total radiological dosage and spectral component levels of radiation for a specific radiation emission machine is disclosed. Said apparatus uses a plurality of electromagnetic emission detectors as a means to separate and analyze the electromagnetic spectral output signals emitted by an individual X-ray, CT, MRI, PET, metal detecting, or foreign object screening machine, etc., into key radiological component intensities.

### PRIORITY

The present application claims priority based on a provisional application with a Ser. No. 61/283,956 which was filed on Dec. 10, 2009.

### FIELD OF THE INVENTION

The present invention generally relates to a portable, measurement apparatus and method as an accurate, objective and independent device for the rapid verification of emitted radiation levels and the patient or subject's total radiological dosage, and as a device to predict when prescribed or safe levels will be met or exceeded.

### BACKGROUND OF THE INVENTION

The ability to make a correct early diagnosis, for example, of certain forms of cancer, may mean detection of very small, early-stage tumors. This makes subsequent successful remedial action much more likely, resulting in recovery and a potentially longer life for many victims. However, early diagnosis and successful treatment may be dependent upon exposure to radiation of sufficient intensity and type to provide adequate contrast to detect a malignancy as early as possible before metastasis, while minimizing the patient's exposure to the biologically harmful effects of the emitted radiation.

In oncology, radiation therapy is often prescribed. A predetermined intense level of radiation is focused on the tumor site for a specified period of time, over multiple sessions, to target the tumor while minimizing the effects on nearby healthy tissue. Total dosage equals the sum of all the therapy session exposures.

Likewise, medical diagnosis, X-ray, CT, MRI, PET, etc. scanners are traditionally used to diagnose and pinpoint disease or trauma in humans and animals. The objective of these scanners may be to provide definitive answers with the minimal amount of radiation so as to minimize the harmful effects of radiation.

Today, metal detecting, or foreign object screening machines, etc., also may use emitted radiation as a means to ‘see through’ clothing, body tissue and transportation containers in order to identify potential weapons, contraband, illegal aliens, etc.

Traditionally, most of the machines that use emission of radiation depend upon a desired setting of the minimal radiation intensity level to achieve near optimal results while minimizing the radiation hazard. Variables that may affect the near optimal results may include garments, skin color, hair color and thickness, tissue density, size and weight of the patient/subject, container construction, material, size, etc.

Additionally, defective equipment could emit potentially harmful spurious and spill-over radiations (unwanted emitted radiations, or radiation outside the area of interest) that go undetected.

Industry standards and operating procedures have been written to quantify the method of determining the optimal radiation level settings for the various applications.

These standards and procedures often require a calibration technique to verify that the radiation intensity level is appropriate for the intended result. However, most of the procedures rely upon the radiation intensity level of the equipment to be correctly set by the operator. Recently, a major hospital was discovered to have set the radiation level eight times higher than required, and thereby overexposed more than two hundred patients over a period of eighteen months before the error was detected.

There are two general methods used to set optimal radiation emission levels: indirect and direct measurement.

The indirect method relies upon periodic calibration of the radiation emitter, and upon the operator verifying that the setting is appropriate prior to each use of the equipment. This method also relies upon the radiation emission equipment to monitor and deliver the proper dosage to the desired area of interest. The calibration of the radiation emitter can be out of calibration for an extended period of time and resulting in the incorrect exposure to the patient/user.

The direct method relies upon a dosimetric measuring means (total accumulated dosage or radiation level times the exposure time) in the immediate vicinity of the area of interest as an independent measurement means of quantifying the exact radiation dosage delivered.

External dosimeters and disposable single-use sensor patch dosimeters are examples (see Widener, et al.). These solutions require attachment of the device to patient a priori. Often wires are required to transfer the dosage level data to the monitoring equipment. Also, the dosimetric devices must be attached to the skin adjacent to actual area of interest, and therefore cannot be attached at the exact point (in three-dimensional space) as the point or area of interest.

Many past attempts have been made to overcome the inherent uncertainty and problems of providing the optimal level of radiation intensity while minimizing the biological hazard of overexposure to the users.

One example is starting with a ‘best-guess’ level and subsequently adjusting the emission level until the contrast is adequate, thereby increasing the total dosage if the first iteration was deemed not optimal.

U.S. Pat. No. 7,495,224 discloses methods, systems, devices, and computer program products include positioning disposable single-use radiation sensor patches that have adhesive means onto the skin of a patient to evaluate the radiation dose delivered during a treatment session. The sensor patches are configured to be minimally obtrusive and operate without the use of externally extending power chords or lead wires. This method relies on the ability to place sensor patches reasonably close to the area of interest without inhibiting the ability of the X-ray machine to perform a correct diagnosis or optimize radiation therapy.

This patent is incorporated by reference in its entirety.

### SUMMARY

A system to measure radiation may include a movable and portable sensor device to measure the radiation from a radiation emitting device and to generate sensor data in response from the radiation from the radiation emitting device, a processor to receive the sensor data from the sensor device and to compare the sensor data with predetermined sensor data to generate a go/no go signal, and a display connected to the processor to display the go/no go signal.

The sensor device may be connected to a housing, and the housing may include the display and the processor.

The processor may process the sensor data to obtain a predictive time when the sensor data will exceed the predetermined sensor data, and the predetermined sensor data may be replaced from a remote device.

The predetermined sensor data may include maximum threshold sensor data, and the predetermined sensor data may include minimum threshold sensor data.

The processor may include replaceable software from a remote computer.

The processor may update lifetime radiation exposure based upon the sensor data.

### BRIEF DESCRIPTION OF THE DRAWINGS

The foregoing objects, features and advantages of the invention will become more apparent from a reading of the following description in connection with the accompanying drawings, in which:

FIG. 1 illustrates a perspective view of a measuring apparatus 100 with control/analysis/readout housing 104, sensor housing paddle 106 interconnected with detachable tether cable 110;

FIG. 2 illustrates a perspective view of sensor housing paddle 106 with a partially cut away sectional view of sensors detectors 107a, 107b, 107n and electronic board 108;

FIG. 3 illustrates a perspective view of control/analysis/readout housing 104 with partially cut away sectional view of a electronic board 112, control switches 122 and touch screen LCD display readout 120;

FIG. 4 illustrates a full system setup, including measuring apparatus sensor housing paddle 106 attached to control/analysis/readout housing 104, typical X-ray machine unit 300 and remote host computer 200;

FIG. 5 illustrates a detailed block diagram of circuitry of measuring apparatus 100;

FIG. 6 illustrates a circuit diagram of the measuring apparatus 100;

FIG. 7 illustrates a circuit diagram of the calibration device 701 of the present invention;

FIG. 8 illustrates another embodiment of the present invention.

### DETAILED DESCRIPTION

None of the prior art solutions address the ability to rapidly and accurately correct the following deficiencies. The present invention achieves the following advantages:

1. Determine and affirm that a specific radiation emission level and spectral component levels of the radiation machine 300 are obtained at a substantially exact point (in three-dimensional space) of the area of interest by a movable sensing device;

2. Determine and affirm that the emission level is acceptable or not acceptable by employing at least GO and NO GO alarms which may be audible or visual;

3. Provide a predictive device such as processor 601 to predict when an accumulated dosage will exceed a predetermined maximum or safe level;

4. Provide an independent controlling and calibration device 701 to form a system to correct for suboptimal levels of radiation exposure of a specific radiation emission device 300 just prior to radiation exposure of the patient/user by the processor 601 remotely controlling the radiation machine 300.

The present invention includes various embodiments for a portable measurement apparatus and method for in situ analysis of emitted electromagnetic radiation, the total radiological dosage of a user, subject or object and spectral component levels of radiation for a specific radiation emission machine. The detecting device for example a sensor housing paddle or equivalent device may be placed at near or at the exact point of interest (in three-dimensional space) for emission exposure. A tethered cable connects the detecting device with a control, analysis and readout housing device of said apparatus. A measurement sequence is initiated prior to exposing the patient, or the measurement sequence is initiated periodically between screening the subjects or objects.

1. One embodiment is the design of a portable, solid-state electromagnetic radiation measurement apparatus 100 that can be near optimized for a specific radiation emission machine per industry standards. The electromagnetic radiation measurement apparatus 100 may include both a plurality of electromagnetic radiation detection sensor channels which may be shown as the sensor A, the sensor B and the sensor N (for example, and the sensor may measure the gamma and X-ray radiation ambient dose equivalent rate, measurement of surface beta-particle flux density, dose equivalent accumulation time, threshold level selection and detection, or other comparable measurements) that may be selected to substantially optimize the performance of a specific radiation emission machine 300. The internal microcontroller software and real-time clock modules which may be implemented in the processor 601 determine the resulting GO/NO GO status indication based upon the processor 601 analyzing the sensor data which may be obtained from the sensors A, B, N (by triggering an audible or visual alarms), display the results and may predict when probable non-compliance will occur or a prescribed level will be exceeded.

2. A second embodiment is the design of a closed-loop automated or semi-automated test self-calibration/alignment method may include the electromagnetic radiation measurement apparatus 100 from the above discussion with an external computer 200 and application-specific software test modules. The measurement apparatus 300 may be positioned at a plurality of substantially exact predetermined locations in three-dimensional space at, and adjacent to, the substantially exact area of interest. A remote external host computer 200 may be programmed to command the radiation emission machine 300 or to notify the operator to set a specified test emission intensity level and the said measurement apparatus 100 evaluates and/or records the measured result and/or computes any necessary adjustment or correction. The cycle may be repeated until the test is completed. Subsequent analysis of the data may include a three-dimensional plot of intensity distribution and emission level accuracy.

3. A third embodiment is the design of additional capability to the radiation measurement apparatus 100 from the above discussion, with a device 801 as illustrated in FIG. 8 to update, customize outputs and/or add optional software application modules remotely which may be stored and the database 603, e.g., via the internet or wirelessly, to ensure ongoing compliance to future standards, etc., after initial purchase of said measurement apparatus.

If total dosage for an identified individual/patient is required such as a lifetime exposure for that individual, the entire search sequence must be carefully documented. For example, if the measurement apparatus is used in place of the patient/subject immediately prior to patient/subject exposure, the measurement apparatus substitutes for the patient/subject in order to verify that exposure levels are: i) correctly set to the ‘best guess’ and subsequent iteration levels, and ii) that the ‘best guess’ and subsequent iteration levels are appropriate for the type of test being conducted. Then the apparatus is removed and the patient/subject is exposed to the exact verified exposure level sequence. The total accumulated dose data is stored in the memory of said apparatus and is available for inclusion into the patient/subject's permanent file, as required.

Reference now should be made to the drawings.

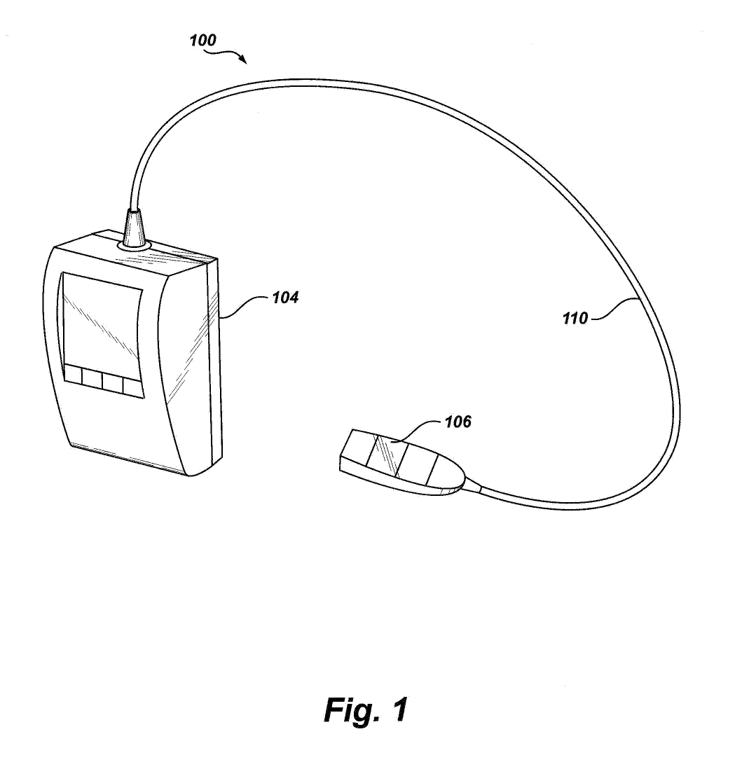

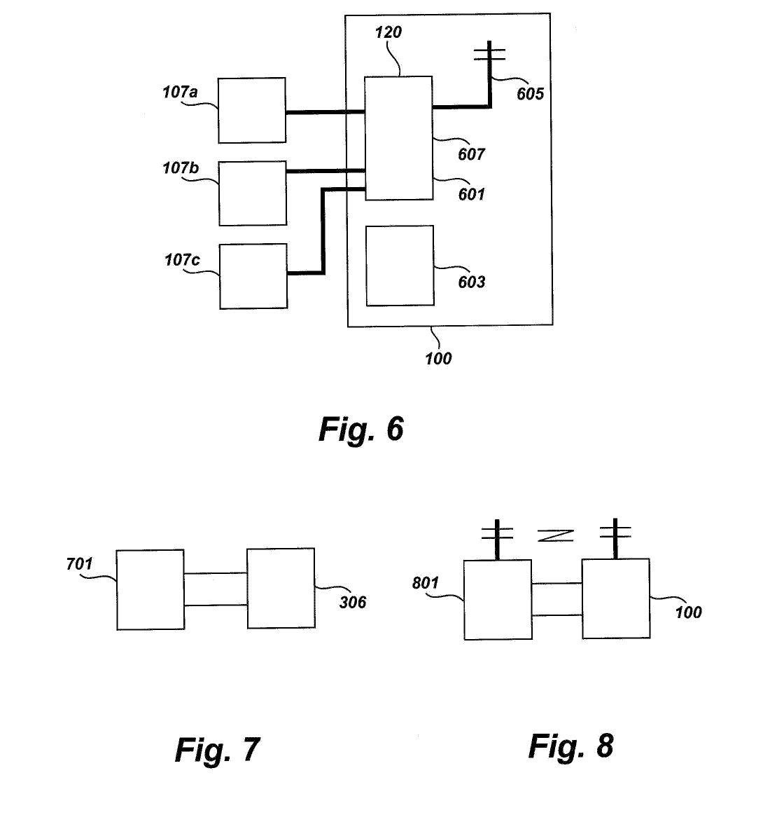

FIG. 1 is a perspective view of a measuring apparatus 100 with control/analysis/readout housing 104, movable sensing device such as sensor housing paddle 106 interconnected with detachable tether cable 110 to connect the sensor housing paddle 106 with the control/analysis/readout housing 104 so that sensor signals received by the sensor housing paddle 106 can be sent electrically to the control/analysis/readout housing 104. The control/analysis/readout housing 104 may include a processor 601 for processing the sensor data E1 E2 . . . En from the sensor A, sensor B, . . . sensor N either individually or together which may be connected to input ports of the processor 601. The processor 601 as illustrated in FIG. 6 may be connected to a database 603 in order to store the sensor data E1 E2 En and threshold sensor data which may include maximum threshold sensor data to indicate the upper limit and minimum threshold sensor data to indicate a lower limit and which may be obtained from factory specification which may correspond to various types of radiation emitting devices such as the radiation generating machine 300 which may be an x-ray radiation. Control switches 122 may control the processor 601 to select a desired data from the database 603 corresponding to the machine 300. The desired data is compared with the sensor data which is input to the processor 601 and the processor 601 may generate a go/no go signal based upon the comparison between the measured sensor data and the upper and lower threshold data. The go/no go signal may be displayed on the display 120 of the housing 100. Furthermore, the processor 601 may store the sensor data in the database 603 over a period of time and the processor 601 may access this data upon command from the switch 122 to perform a regression analysis or other type of analysis which may predict when the radiation machine 300 may begin to malfunction by emitting radiation reaches out of the acceptable range for the radiation machine 300.

Furthermore, the processor 601 may store the sensor data in the database 603 over a period of time and the processor 601 may access this data upon command from the switch 122 to record total accumulated patient/subject exposure data for inclusion in the patient/subject's permanent file, as required.

The database 603 may retain the lifetime radiation exposure of a identified individual/patient in order to facilitate the correct dosage. The database 603 may retain an identifier such as a Social Security number of the patient to be examined and may retain the lifetime radiation exposure of the patient. After treatment, the lifetime radiation exposure of the patient is updated to reflect the new exposure which has applied to the patient. The processor 601 may be connected to an antenna 605 in order to provide for wireless communication to device 701 or device 300. Alternatively, the processor 601 may include output 607 to connect to the Internet to provide for connection to device 701 or device 300.

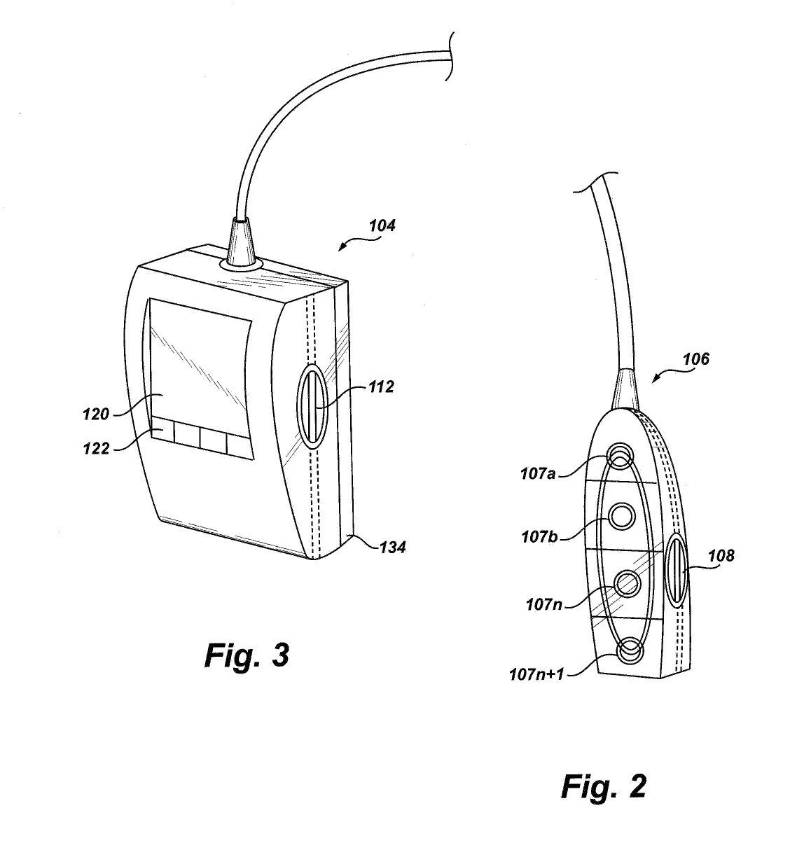

FIG. 2 is a perspective view of the movable sensing device 106 for example the sensor housing paddle 106 with a partially cut away sectional view of sensors detectors 107a, 107b, 107n and electronic board 108 to connect the sensors 107a, 107b, . . . 107n to the processor 601.

FIG. 3 is a perspective view of control/analysis/readout housing 104 with partially cut away sectional view of a electronic board 112 which may include the processor 601, control switches 122 to control the processor 601 and touch screen LCD display readout 120 to display the results and or calculations from the processor 601.

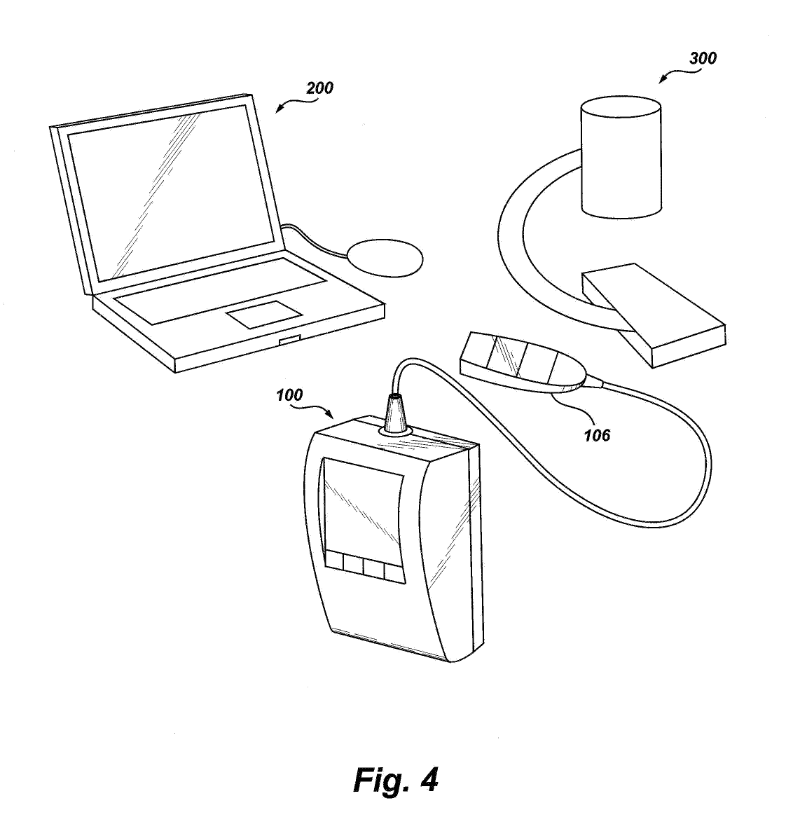

Referring to FIG. 4, sensor housing paddle 106 is placed in the proximity of X-ray machine unit 300, on or near the X-ray machine sensor/detector table 302 in the plane of interest, where the patient/subject/object is to be exposed to radiation emitted by said X-ray machine unit emitter 301. Said X-ray machine is then set to a predetermined level of radiation emission by an operator or by a software program. Said software program may be directly initiated by said X-ray machine unit 300, by said remote host computer 200 interfacing means, or by said measurement apparatus 100 or other type of interfacing device.

Now referring to FIG. 3, control switches 122 on measuring apparatus control/analysis/readout housing 104 are set to the desired measurement mode (for example, measurement of radiation level, dosage, etc., by manual control or threshold measurement sequence, etc.).

Again referring to FIG. 4, said X-ray machine unit 300 initiates the radiation emission cycle by the said remote computer 200.

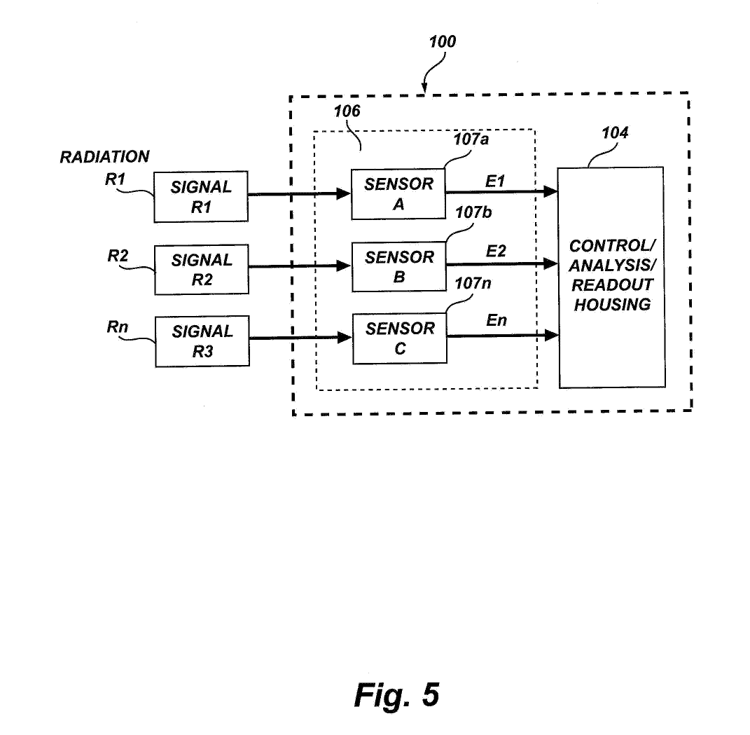

Again referring to FIGS. 2 and 5, the plurality of sensors 107a, 107b, 107n, which may included in said sensor housing paddle 106 (FIG. 2) detect the radiation signals R1, R2, Rn (FIG. 5), and convert said radiation signals to electronic signals E1, E2, En. Then electronic board 108 (FIG. 2) converts said electronic signals to digital data signals D1, D2, Dn. (FIG. 5).

Again referring to FIGS. 1 and 5, the said digital data signals D1, D2, Dn. (FIG. 5) are sent from said sensor paddle housing 106 (FIG. 1) through tether cable 110 (FIG. 1) to the control/analysis/readout housing 104 (FIG. 1).

Again referring to FIGS. 3, 4 and 5: Said digital data signals D1, D2, Dn. (FIG. 5) are sent to electronic board 112 (FIG. 3) an order the processor 601 where they are analyzed based upon the stored data such as the threshold sensor data in the database 603. The results are presented on display readout 120 (FIG. 3) and trigger GO or NO GO, etc., alarms A1, A2, An (FIG. 5). The results are stored on said electronic board 112 (FIG. 3) or in the database 603.

Now referring again to FIG. 4, during closed-loop operation, communications are sent by wired and/or wireless interfacing device such as the antenna 605 or the Internet connection 607 from to and from said measuring apparatus 100, to and from said X-ray machine unit 300 interfacing device, and/or said remote host computer 200.

The present invention includes the following features.

1. A portable, solid-state gamma and X-ray measuring apparatus that can be optimized for a specific radiation emission machine per industry standards. The radiation measurement apparatus includes a plurality of electromagnetic radiation detection sensor channels (for example, gamma and X-ray radiation ambient dose equivalent rate, measurement of surface beta-particle flux density, dose equivalent accumulation time, threshold level selection and detection, etc.) that are selected to optimize the performance of a specific radiation emission machine.

2. The measuring apparatus may include a plurality of radiation sensor detector channels which may be for substantially parallel detection of a plurality radiation of emission signals depending on the types of radiation emitted by a specific radiation emission machine.

3. The measuring apparatus may include the apparatus including internal microcontroller, software and real-time clock modules determine the resulting GO/NO GO status indication (by triggering audible alarms) compared to approved procedures and/or industry standards, and displays the result on an integral readout.

4. The measuring apparatus may include the apparatus including internal microcontroller, software and real-time clock modules to determine optimal GO/NO GO status indication (by triggering audible alarms) compared to approved procedures and/or industry standards, displays the result and further predicts when probable non-compliance will occur or a prescribed level will be exceeded.

5. The measuring apparatus may include the apparatus having an interfacing device with the specific radiation emission machine and/or host computer for radiation level and dosage level output control and calibration of the radiation emission machine.

6. The measuring apparatus may include said apparatus having an interfacing means with a remote host computer for archival, fully-automated or semi-automated tests and output calibration of a specific radiation emission machine.

7. The measuring apparatus may include the apparatus having an internal software remote updating means and/or means for adding optional application modules to maintain compliance over time when approved procedures and/or industry standards are changed.

The present invention uses a portable radiation measuring apparatus wherein the radiation measurement sensor housing paddle is carefully placed in the plane of emission and at the substantially exact point of interest in three-dimensional space, whether at the skin surface, X-ray machine detector surface, or anywhere in between. In this way the substantially exact radiation dosage level is measured accurately, objectively and independently to monitor, control or calibrate and record the radiation dosage level of a specific radiation emission machine. This may be repeated for each and every machine.

In conclusion, the present invention provides a portable measurement apparatus and method for independent in situ analysis of emitted radiation, the patient or subject's total radiological dosage and spectral component levels of radiation for a specific radiation emission machine. Said apparatus uses a plurality of electromagnetic emission detectors as a device to separate and analyze the electromagnetic spectral output signals emitted by an individual X-ray, CT, MRI, PET, metal detecting, or foreign object screening machine, etc., into key radiological component intensities. The subsequent analyses are used to optimize the probability for correct diagnosis, tumor treatment session exposure, or detection of the presence of metallic or foreign objects, by a qualified analyst, operator or screener, while minimizing the biological hazard effects due to accumulated exposure to the radiation levels received by the patient, subject or object. The electromagnetic radiation signals are converted into first electronic signals and then digital data signals by the said apparatus. Then said data signals are processed, and compared to previously stored information of the specific radiation emission machine's desired emission levels and total exposure to determine if the proposed radiation level, as set, (by means of audible alarms) is either GO (acceptable, in compliance, or as prescribed) or NO GO (not acceptable, non-compliant, or not set as prescribed) according to industry standards or approved procedures, and/or used to predict when future accumulated total dosage is likely to exceed prescribed or maximum safe levels. The results are also displayed on said apparatus for the operator, and they are archived in said apparatus. If said results are not acceptable, the analysis can be further used to troubleshoot the specific radiation emission machine's radiation level settings, thereby providing an independent measuring and calibration device for correcting the unacceptable condition. The resulting analysis may also be wired or wirelessly sent by interfacing device to a host computer for archival. In addition, a means for software updates and optional software modules is provided to further customize outputs so as to maintain compliance with future industry standards.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A system to measure radiation, comprising:
a movable and portable sensor device to measure the radiation from a radiation emitting device and to generate sensor data in response from the radiation from the radiation emitting device;
a processor to receive the sensor data from the sensor device and to compare the sensor data with predetermined sensor data to generate a go/no go signal;
a display connected to the processor to display the go/no go signal.

2) A system to measure radiation as in claim 1, wherein the sensor device is connected to a housing.

3) A system to measure radiation as in claim 1, wherein the housing includes the display and the processor.

4) A system to measure radiation as in claim 1, wherein the processor processes the sensor data to obtain a predictive time when the sensor data will exceed the predetermined sensor data.

5) A system to measure radiation as in claim 1, wherein the predetermined sensor data may be replaced from a remote device.

6) A system to measure radiation as in claim 1, wherein the predetermined sensor data includes maximum threshold sensor data.

7) A system to measure radiation as in claim 1, wherein the predetermined sensor data includes minimum threshold sensor data.

8) A system to measure radiation as in claim 1, wherein the processor includes replaceable software from a remote computer.

9) A method to measure radiation, comprising the steps of:
measuring the radiation and generating sensor data in response from the radiation;
receiving and comparing the sensor data and to compare the sensor data with predetermined sensor data to generate a go/no go signal;
displaying the go/no go signal.

10) A method to measure radiation as in claim 9, wherein the method includes the sensor data to obtain a predictive time when the sensor data will exceed the predetermined sensor data.

11) A method to measure radiation as in claim 9, wherein the predetermined sensor data may be remotely replaced.

12) A method to measure radiation as in claim 9, wherein the predetermined sensor data includes maximum threshold sensor data.

13) A method to measure radiation as in claim 9, wherein the predetermined sensor data includes minimum threshold sensor data.

14) A method to measure radiation as in claim 9, wherein the method includes the step of replacing the software.

15) A system to measure radiation as in claim 1, wherein the processor updates lifetime radiation exposure based upon the sensor data.

16) A method to measure radiation as in claim 9, wherein lifetime radiation exposure is updated based upon the sensor data.
